(19) United States
(12) Patent Application Publication
(10) Pub. No.: US 2001/0037450 A1
(43) Pub. Date: Nov. 1, 2001

(54) System and method for process protection

(76) Inventors: Evgueny A. Metlitski, Tinton Falls, NJ (US); Dmitry B. Utyansky, St. Petersburg (RU)

Correspondence Address: Stroock & Stroock & Lavan LLP, 180 Maiden Lane, New York, NY, 10038, US

(21) Appl. No.: 09/797,108

(22) Filed: Mar. 1, 2001

Related U.S. Application Data
(60) Provisional application No. 60/186,538, filed on Mar. 2, 2000.

(51) Int. Cl. H04L 9/00

(52) U.S. Cl. 713/152

(57) ABSTRACT

A method of developing a protected software application comprises identifying segments of the application to be protected and compiling those segments according to a protected instruction set. The protected segments are then linked together with the unprotected segments for distribution. The protected segments can only be executed using a trusted module connected to a computing device. The trusted module comprises a virtual machine programmed with an instruction set corresponding to the set of instructions used to compile the protected segments. Using the trusted module, the state vector of the process of execution is monitored to insure integrity of the process. Various encryption and technological security measure may also be used.

### DESCRIPTION OF RELATED APPLICATIONS

This Application claims priority to U.S. Provisional Application Ser. No. 60/186,538, filed on Mar. 2, 2000.

### FIELD OF THE INVENTION

The subject invention relates to the field of information processing security and, in particular, to a system and method for providing security and authentication of the process or dynamic state of an executable program in an open architecture computer system.

### BACKGROUND OF THE INVENTION

Computer fraud is an ever growing problem in today's electronic environment. Computer fraud and related thefts cost companies and individuals millions and threaten to stifle the growth of electronic business. Inadequate computer protection systems also leave valuable information vulnerable to hackers. Thus, providing solutions for the protection of computer software has become an urgent objective.

Generally speaking, a main objective of software protection is to protect programs and data from computer piracy. For this purpose, hardware and software techniques have been developed to increase the difficulty in gaining access to and copying or using programs and data illegally. Technical solutions applied to protection systems are quite diverse. Most are based on the techniques of enciphering/deciphering of program data and codes using special software, hardware or combined means. However, as evidenced by the growing concern of computer fraud and security, the problem, even on a program and data level, has yet to be adequately solved.

The problem is that open architecture computer systems (i.e., systems having an architecture whose specifications are public) are very susceptible to external influences that enable hackers to tamper with programs, data, and the processes run when programs are executed. Special systems of applied hardware and software have been used by hackers to tamper with others' programs and data, such as debuggers, logic analyzers and emulators, to name a few. Although these devices were developed for programmers to aid in the development and debugging of their applications, they have proved to be allies to hackers and thieves.

While many solutions to protect programs and data have been developed, as set forth in further detail below, the potential for influences on processes during the execution of applications remains a primary concern regarding the security of computer platforms. Openness of computer platforms and potential for modification of processes remain the most troublesome of the problems in information security. For instance, by influencing a process, a hacker can influence or modify the results or output of an application, thereby potentially costing the users valuable time and money.

The main objectives of software protection systems include:

a) impossibility to reveal the algorithm of a program;

b) impossibility of any unauthorized influence on the process of program execution, which changes the logic of the program and/or protocol of program interaction with user;

c) guaranteed correctness of time parameters, related to user actions, which are determined by the program logic;

d) impossibility of arbitrary changes of the key data or parameters of the program and/or results of its work;

e) authenticity of the process and the process name.

Integral in these objectives is the term “process”, which is fundamental to Computer Science. While a program itself is a static set of directives, execution of the program is a dynamic activity whose features change in time. This activity is called a “process”. The state of a process at any given time is generally referred to as the “process state”. The difference between a program and a process is one of the basic concepts of modern information systems. Unlike the technology of program and data protection, set forth below, process protection protects the process itself, but not necessarily the programs and data against unauthorized access, use or copying. As used herein, “process protection” generally means to prevent external influences on the logic of a program, the time period of the process execution, and the program's transient and final states. As will be seen from the following description of the prior art, protection of processes in their dynamic state has yet to be adequately addressed.

U.S. Pat. No. 5,007,082 to Cummins illustrates a technique for providing protection by enciphering and deciphering information using an algorithm as the information is communicated between the diskette controller and the data transfer buffer area within system RAM, which works on the BIOS level. Another possible technique of protection is to detect unauthorized changes in the program code or data using multiple digital signatures as described in U.S. Pat. No. 5,572,590 to Chess. Such techniques, however, can be relatively easily defeated on open architecture computer systems using existing means of program analysis.

To provide a greater level of protection against hacking attempts special hardware means have been developed. In some cases, these protection systems are built directly into the Integrated Circuit (IC) of the memory module and/or the CPU. U.S. Pat. No. 5,563,945 to Gercekci describes the use of an address scrambler. The address scrambler alters order of words in the memory, which makes analysis of the programs more difficult.

U.S. Pat. No. 5,987,572 to Weidner et al., on the other hand, describes use of a dynamic encryption interface between the processor and memory, which incorporates means of encrypting and decrypting of data being written or read by the memory. This system, in particular, uses keys, depending on the accessed address, and means of decrypting and re-encrypting of the data word using updated key, according to some update algorithm, governed by a state machine. While this “dynamic encryption” improves system security against “record and playback” attack, it does not fully address process protection.

Cryptographic protection systems using a unique key built into the microprocessor are described in U.S. Pat. No. 5,034,980 to Kubota and U.S. Pat. No. 4,633,388 to Chiu. In such systems, the microprocessor executes a program whose code has been enciphered beforehand using the indicated unique key, i.e. the processor can run only the programs which have been prepared specially for it. While such hardware security means provide a high level of protection, they depend upon expensive IC manufacturing technologies and are not flexible and universal enough for a widespread public use.

In systems where the protection means are built into such functional components of the computer, such as the processor, memory, or input/output controllers, it is necessary to provide physical integrity of those components. Such a solution is described in U.S. Pat. No. 5,007,083 to Constant. Although this solution can be used in “special-purpose” systems, such as government or military systems developed for a particular, specialized use, it is of little use in open architecture computers, such as personal computers.

Protection systems combining hardware and software means have been the most widely adopted, since they are the most universal and available for public use. Protection of software against unauthorized copying or use can be provided, for example, using direct protection of one of the memory devices of computer containing protected programs and data. Such a solution is described in U.S. Pat. No. 5,081,675 to Kittirutsunetorn and U.S. Pat. No. 5,533,125 to Bensimon et al. These protection systems use special devices (i.e., coprocessors, electronic keys, cartridges) connected to one of the ports of computer. In simple systems, such devices store codes of keys (e.g., electronic keys) used for authentication of a copy of a software product or enciphering/deciphering of program and data segments. In more advanced systems, secure coprocessors are used to provide secure execution of program code segments. The latter systems are described in U.S. Pat. No. 4,817,140 to Chandra et al.; U.S. Pat. No. 5,109,413 to Comeford et al.; and U.S. Pat. No. 5,754,646 to Williams et al.

The protection technique of these systems is based on separating the software distributed on conventional media (floppy disks, CDs) into open and closed parts. The latter is enciphered using a cryptographic algorithm. The open part of software is executed by the base computer, while the closed is deciphered and executed by a coprocessor protected both physically and logically. Logical protection is provided using a system of cryptographic keys stored in a physically protected coprocessor and/or in a special token cartridge. Hence, the complete text of the program is not given to a user in an analyzable form and any attempts to copy the software are useless, since the software copies will not work without the coprocessor and token cartridge.

The concept of dividing software into two parts finds another implementation in modern networked environment—when one portion of software is executed on user computer, while the other portion, without which the software is not fully functional, is executed on a vendor server. This way the user obtains the full functionality of the original program without having access to the full original program code. This approach is described in U.S. Pat. No. 6,009,543 to Shavit. These systems, however, only separate the software for the purpose of encrypting a part of it or remotely executing a part of it. Again, this approach does not fully solve the problem of process protection.

An important feature of such systems is separation of the protected software from the ability to execute the software. This separation allows the development of important commercial uses such as the ability to transfer rights to use software, renewal of the right to use software, metering software usage time and software rental. To implement these techniques the coprocessor usually includes real-time clock or counter of software run times. The clock is initialized either by a supplier of the software (manufacturer of coprocessors), or directly when installing the program on a user computer. As is described below, clock or counter initialization approaches can encounter difficulties related to uncontrollable user reaction time.

A more sophisticated software usage metering system is described in U.S. Pat. No. 5,083,309 to Beysson. Such systems make it possible for the software to be rented, with the rental user paying a fee based on the time the software actually ran. The protection mechanism uses a memory card and a card reader associated with the computer to run the software. Various intermediate results are stored in the memory of the card and not in the memory of the computer. Similar to the Shavit system, a substantial disadvantage of this protection method is that the programs' algorithms are open to analysis and possible modification by a malicious user. Enciphering of data transmitted to and from the memory card, as well as ensuring that the time required for the execution of the various portions of the software does not become too long, is insufficient to resist the unauthorized actions. Moreover, ensuring that the time for execution is short is not acceptable for the majority of programs, since they interact with an end user, which introduces unpredictable delays into operation. Disabling of the clock while executing procedures involving interaction with the user, which is described in the Beysson patent to mitigate this problem, compromises the whole execution time metering system.

Another application of cryptography is to provide means to check software code or data authenticity. Usually, this is done using some variation of private/public encryption to enable the loader to verify that the software is indeed provided from the certified source. An example of such an approach is described in U.S. Pat. No. 5,724,425 to Chang et al., where software is distributed in a signed “passport”, including the software writer's name and license. Only when the relevant information in the “passport” is valid, can the software be executed.

The software that performs the verification and makes access control-related decisions, as well as the software being protected itself, can be run inside some trusted environment. An example of such software is described in U.S. Pat. No. 6,175,924 to Arnold, which describes a method for certifying the authenticity of an application program after loading it into the physically secure module for execution and for securely associating such application programs with data held in a persistent storage area. A unique name of the application, signed together with its code, is used to control access to this persistent storage.

Smart Cards have also been used to protect data. Historically, smart cards emerged as a secure and reliable alternative to cards utilizing magnetic strips. Smart cards first appeared as chip cards, which contained a small amount of memory that could be read or written by a special device. These cards, however, provided little protection and were usually employed in low-cost systems, such as pay phones.

True smart cards were developed, incorporating more sophisticated circuitry, including a CPU and some amount of working RAM. Because they provided superior protection (internal memory could be read/written through a protocol with the support of the card's CPU and only if the reader supplied a proper password), these cards were used in many applications although most uses were not related directly to personal computers. Later, with the growth of the Internet and rising concerns about security issues, smart cards began to be used in applications more directly related to personal computers. Examples of common applications were personal identification and authentication, and access to sensitive data storage, such as an e-wallet.

Most smart card applications use only a limited and hard-program set of functions (file access, some cryptographic parameters) provided by the card manufacturer. Advanced cards with downloadable programs are more frequently being used as the industry responds to the growing need for unification. However, limitations on on-card RAM and EEPROM sizes limit the functionality of the on-card program.

As can be seen from the above review, the encryption of data and application code is known. However, to be used on a PC, this encrypted data or code must be transformed into an open form (i.e., it must be decrypted usually on the same PC). As a result, the decryption algorithm, crypto-keys, and all other parameters of deciphering are open and subject to analysis by unauthorized individuals. Smart cards and other hardware solutions have similarly failed to provide adequate protection due to their limited processing power or specialized nature. Thus, while current systems provide a modicum of protection to software code and data, no present system provides comprehensive process protection that is available for widespread public use.

### SUMMARY OF THE INVENTION

The present invention overcomes the shortcomings of the prior art. The present invention generally comprises a system and method for providing protection to the processes executed on a computer. Unlike the prior art, the exemplary embodiments and equivalents disclosed herein provides a low cost trusted computer platform that comprises a trusted module connectable to a host computer, such as a personal computer (PC), a personal digital assistant (PDA), or other computing device, that enables the secure execution of an application. The trusted module includes a virtual machine and security kernel upon which all of the protection mechanisms are built. The system is flexible due to the smaller size of the security kernel, which allows for smaller amounts of resources to be available to the kernel. Moreover, because only portions of an application are executed on the trusted module limited processing resources are necessary. It further eliminates any possibility of unauthorized external influence on the processes and supports a wide variety of public applications. Yet further, the present invention provides traditional protection features, such as protection of programs and data from copying or unauthorized access and use. In general, the exemplary embodiment of the present invention is capable of providing security to all modern information infrastructures.

The invention describes the technology referred to herein as Protected Execution of Programs (PEP technology). The invention is technology is based on the concept of process protection and includes methods of development and execution of programs and special hardware, firmware and software to support the process protection. The invention provides, among other intended benefits that will be described hereinafter:

Protection from unauthorized reading of the executable code (algorithm) and data.

Protection from unauthorized alternation of executable code or static data of the program (authentication of program and data).

Protection from unauthorized reading of the current state of the process being executed at any point of its execution.

Protection from unauthorized introduction of changes into the current state of the process being executed at some point of its execution.

Monitoring and checking of time parameters of the process being executed.

Monitoring and checking of the open fragments of the process being protected.

An ability to store results of computer program in non-volatile memory of a detachable device, so that these results can be later used by the program or transferred to another computer.

Protection of the non-volatile memory from unauthorized access.

Provision to make each copy of software unique with ability to provide means of access control.

In the invention these goals are achieved using a special technology of software preparation on its development stage and a special technology of software execution on its operation stage. The technology, on its execution stage involves interaction of a standard computer (for example, IBM PC-compatible) and of the special additional device Trusted Module, connected to the computer using one of the standard interfaces and including at least the following units: Cryptolnterpreter (CI), Reference Clock (RC) and Non-Volatile Random Access Memory (NVRAM). One possible implementation of Cryptolnterpreter is a software implementation which assumes that the trusted module should have at least a CPU, ROM containing control program, and RAM.

The use of the PEP technology includes the following steps among others:

identification of software fragments that should be protected;

implementation of the identified fragments using a high or low level programming language, their translation to the executable code using special software (CryptoCompiler or CryptoAssembler) and, possibly, additional information such as a key (CryptoKey);

when necessary—initialization of non-volatile memory (NVRAM) of the trusted module and writing of the corresponding key information (CryptoKey) into the NVRAM;

loading and execution of the program on a user computer, when the protected fragments of the program are initially loaded into the memory of the computer as a part of software and then are executed during an interaction of trusted module and computer in one of the modes of work described in this invention, namely:

(a) by a device retrieving and interpreting the executable code and data of the protected fragments in a word-by-word mode as the program is being executed with possible deciphering of commands and data using a deciphering key stored in NVRAM or ROM of the device. Thus, the working data (components of the state vector) of the protected process can be read by the trusted module from computer RAM and transferred by the trusted module back to computer RAM for storage when necessary, possibly involving the use of deciphering algorithms while reading data and enciphering algorithms while writing data. To increase security it is possible to use address of the word being read/written as an additional key parameter for the cipher. In addition to application of algorithms of enciphering/deciphering it is possible to use cryptographic scrambling of addresses of the words being read/written in order to hamper the analysis of the protected fragment logic by analyzing the order of accesses to a computer memory. In addition, for this purpose the device can insert random (independent from the logic of the protected fragment execution) read/write requests to the memory of the host computer; or

(b) by loading segments of program code to the trusted module with their further execution (interpretation) by the trusted module with possible deciphering before execution and/or checking of cryptographic checksums of the loaded fragment. In this mode, the working data (components of state vector) of the protected process are stored in the internal RAM of the trusted module and, when necessary, can be swapped out for storage to the host computer RAM with possible enciphering and/or supply of cryptographic checksums to facilitate checking data integrity later.

It should also be understood that it is possible to use intermediate variants between the (a) and (b) versions, for example developing of the (a) version by adding cache buffer into trusted module for minimization of data exchange between the trusted module and computer memory, changing the size of internal RAM of trusted module, changing the size of loaded segments in version (b), etc.

This invention also describes a technique for interaction between the trusted module and the host computer, as well as a variant of organization of interaction of processes executed by the host computer and the trusted module.

Unlike smart cards, the trusted module of the present invention can act as a key to prevent access to data on another device, securely store data that is accessible to the user and inaccessible to the user, prevent execution of a process, provide identification, authorization, or authentication of the trusted module holder, modify itself, protect itself, and initiate processes based on dynamic instructions.

While the main purpose of a smart card is the predetermined execution of entire processes utilizing known content, the trusted module of the present invention is a closed virtual machine with a dynamic architecture. In other words, the trusted module can process any application, including real-time processes. It can execute internal processes, and at the same time, interact with external machines such as PC's. Furthermore, the execution of joint segments of processes with a PC is possible. The trusted module controls those segments of the process that are executed on an external machine such as the PC. Thus, the processes executed on a PC and interacting with the trusted module also become closed processes.

Unlike smart cards, the trusted module of the present invention has a much greater computing and memory resources, and its internal structure supports the dynamic architecture of the trusted module and other processes and parameters mentioned above.

The present invention can be used in a wide variety of mainstream applications. While the aggressive growth of Business-to-business (“B2B”) commerce has created an infrastructure that will enable businesses to save millions of dollars in procurement costs, the new technology has created a vehicle for potential multimillion-dollar fraud and/or theft. The present invention would enable businesses to create a totally secure B2B infrastructure that would eliminate companies' potential exposure and liability. As such, the present invention would enable a secure environment across all components of ERP/XRP.

Furthermore, the present invention would provide a mechanism for the protection of proprietary information of global computing devices. Thus, travelers could confidently bring their mobile computing devices with them without fear of losing valuable data. The computer game and gambling industries could also benefit from the present invention. The present invention would eliminate the potential for off-line cheating, where no limitations on the time or place of the games are specified. The possibilities for use in the on-line gambling industry are wide. A home electronic casino that does not require the use of electronic communications, such as the Internet, in order to execute game actions and monetary transactions, could be created. Due to the secure environment created by the present invention, betting, game-play, and payoffs, could be executed autonomously on the user's computer. Moreover, a new universal multifunction game apparatus for casino applications based on the present invention could be created. Mass lotteries could also be held using the present invention. Electronic game tickets could be purchased using an ordinary PC. The ticket processing system could include storage of the customer name, ticket number, time stamp, and other information on a trusted module.

Because the present invention protects the integrity of the process and data, the present invention can be applied to any situation where the integrity of a user's data is required, such as but not limited to TV or radio quizzes, competitions, and games, or artistic work.

Many applications in the financial industry require data protection that cannot be accomplished using current technologies. The present invention, however, provides a secure environment that would allow for a new form of credit card that would require only a single card that can process transactions from many different credit card companies or numbers, completely secure from the possibility of forgery. Yet further, financial institutions would have the ability to track external transactions by use of a tagging system very much like electronic bar codes. The present invention could also eliminate the use of the printing of paper receipts and fiscal purchase records. Using the present invention, a secure e-commerce type wallet could be created which could not be tampered with because the card would require the physical attachment to an authorized device in order to retrieve any monetary value stored on the card, an authorization process, such as password or biometrics, prior to access to the monetary content, and an inability to remotely access the card.

In distance learning applications, the present invention could provide a secure environment for the administration of “distance tests”.

Because the present invention provides protection to the process of an application in its dynamic state in addition to the program code and data, the present invention could provide protection against modification of the infrastructure logic of a PC which allows viruses to transparently travel within PC's. As such, the present invention could provide strong anti-virus protection. The present invention also provides protection against internal hacking and user-identification when digital content is being transferred between users. Yet further, the present invention could be used to create a secure environment for electronic notaries to create an objective record of documents, requisitions, electronic signatures and electronic contracts. Ticketing and on-line postal services offer the possibilities for use of the present invention. Still further, the present invention could be used to create a secure digital information card for identification of the holder. The card could include photographs, facial scans, fingerprints, retinal scan information, general descriptive information, other biometric information or processing capability, and/or passwords. As such, the present invention can be applied to applications such as by way of non-limiting example passports, personal identification, employee ID's, drivers' licenses, credit cards, electronic keys, and access to on-line storage of essential medical, legal or other information.

Other objects and features of the present invention will become apparent from the following detailed description, considered in conjunction with the accompanying system schematics and flow diagrams. It is understood, however, that the drawings, which are not to scale, are designed solely for the purpose of illustration and not as a definition of the limits of the invention, for which reference should be made to the attended claims.

### BRIEF DESCRIPTION OF THE DRAWINGS

FIG. 1 shows a graphical representation of an exemplary set of possible “trajectories” of the process execution;

FIG. 2 shows the main targets of the process protection technology;

FIG. 3 is a schematic diagram of an exemplary embodiment of the general architecture of the Trusted Module and supporting technology;

FIG. 4 is a schematic diagram of an exemplary embodiment of the structure of the object machine of the trusted module;

FIG. 5 is a schematic diagram of an exemplary embodiment of the structure of the virtual machine of the trusted module;

FIG. 6 is a schematic diagram of the hardware components of the technology of protected execution of programs and their interaction;

FIG. 7 depicts an exemplary implementation of the Cryptolnterpreter;

FIG. 8 illustrates a process of software preparation for its execution within an exemplary embodiment of the PEP technology framework;

FIG. 9 shows an exemplary process of the process of cryptocompiling illustrated in FIG. 8, but in greater detail;

FIG. 10 illustrates the logical interaction between an open process of the host computer and an protected process executed using the Trusted Module when executing software within the PEP technology framework;

FIG. 11 is similar to FIG. 6, but illustrates in greater detail the logical interaction between the Trusted Module and the host computer when executing software within the PEP technology framework;

FIG. 12 shows the variant of mapping of logical addresses of the address space of the PEP virtual machine to the host computer memory when using the scheme with word-by-word exchange;

FIG. 13 is similar to FIG. 12 and shows in more detail the variant of design of address mapping, using fixed and variable keys as mapping parameters; and

FIG. 14 shows the distribution of the protected process state vector components in the physically protected Trusted Module and the host computer RAM.

### DETAILED DESCRIPTION OF THE PREFERRED EMBODIMENTS

There will now be shown and described in connection with the attached drawing figures exemplary embodiments of a system and method for developing and protecting the processes of a software application.

According to an exemplary embodiment of the present invention, a system comprising a physically secure device in communication with a conventional open architecture computer (e.g., a personal computer) provides a trusted computing platform that protects the processes of an application in its various dynamic states, as well as the programs and data of the application.

In general, with reference to FIGS. 1-14, a method for developing a protected application 7 for use on an open architecture host computer 1 comprises identifying one or more segments S2, S4, and S6 of the application 7 to be protected and compiling the identified segments using a cryptocompiler into cryptocode. The remaining segments S1, S3, and S5, i.e., those not identified to be protected, are compiled using a conventional compiler 5 into a known form of machine code. The cryptocode and the machine code are then combined using a linker 6 to form the resulting protected application 7. As will be described in further detail below, because the resulting protected application 7 can only be operated by a computer in communication with a secure device capable of executing the cryptocode, the application 7 can be distributed using commonly used information distribution means, such as for example, CD-ROMs or other optical storage mediums, floppy disks, tapes, or download from a communications network such as the Internet.

An exemplary embodiment of the present invention encrypts the data in code using a program that is itself encrypted and requires a co-processor or trusted module program to operate with encrypted programs compiled by the encrypted compiler. All of the forms of data, however, can be encrypted using a similar process that encodes data to require a co-processor for decoding.

As such, the same co-processor or trusted module must then be used as part of the process that allows access to and deprocessing of the data. As will be discussed further in connection with FIG. 1, the execution of a process creates a trajectory of that process which requires both a co-processor and a host processor such as a PC computer. If both processes are not present, the application will not run.

With reference to FIG. 1, there is shown an illustration of the set of possible trajectories of a process. At each moment of time, a process is in a particular state, which includes all of the information necessary to analyze the process. This information includes, at the very least: (1) the executable code of program, (2) an indication (address) of the next command to be executed, and (3) the values of all variables and data. As the process runs, its state changes. However, the program code during its execution does not change. For the purpose of analysis, it is convenient to separate all of the variable parts of the process state and study them as a vector of the process state. Thus, the process comprises two components: (1) a program (the static element) and (2) a State Vector of Process or “SVP” (the dynamic element).

During execution, the process passes through a time-ordered sequence of states. Each state is characterized by a multi-component vector SVP (p₁, p₂, . . . , p_{N}|tᵢ), where pₙ, nε[1,N] is a set of parameters of the process that describes the process state at discrete time points t₁, . ., tᵢ, . . . , T. The computer's processor, the function of which is to change the process state, performs transfer of the process from one state to the next one. The completed process passes through all its states, from the starting SVP (p₁, p₂, . . . , p_{N}|t₁) to the final SVP (p₁, p₂, . . . , p_{N}|T).

If N+1 components of the SVP are considered to be the axes of (N+1)-dimensional space, then the deterministic process is characterized by a unique trajectory in this space.

However, the trajectory of real processes often are not predetermined. A large number of internal and external factors influence the execution of the process resulting in changes to the process's trajectory in the (N+1)-dimensional space of the SVP components. These factors include, but are not limited to, the internal vagueness of processes that use random number generators, interactions with the user, and the timing of events in a real time process. Changes in the trajectory caused by the influence of these and other internal and external factors are distinctive of a real-time process. The set of possible trajectories of the process depicted in FIG. 1 are derived from (1) the internal uncertainties of the process (∘); (2) interactions with the user (Δ); and (3) events which are determined by time (□). Assuming that the ultimate goal of any process is to provide the user with objective results, the most important events are marked on the graph by the points where the trajectory of the process branches.

Time is one of the factors that define the trajectory of a process. There are two types of time for the computer processes: (1) internal discrete time of the process and (2) external real time of events related to the execution of the process. The relationship between these two types of time is important for the process control. Real time is an objective external factor, which changes independent of the process. Internal time, however, is subject to external influences and, therefore, can be changed. Significant changes of internal time scale are one of the symptoms of a violation in process execution. Therefore, the monitoring of time flow becomes an important objective in process protection.

Based on the above model of a process, it is possible to define the process protection problem as:

Providing the trajectory of process execution that exactly corresponds to all external and internal events relevant to the process;

Providing security of the final value of the state vector of the process or its essential components that determine the results of the process;

Providing control over the time parameters of the process.

In order to meet these demands, it is necessary to provide protection of the vital elements which comprise the process and which determine its trajectory in the space of the SVP components and in time. It is possible to identify the specific functions in the general tasks of process protection as:

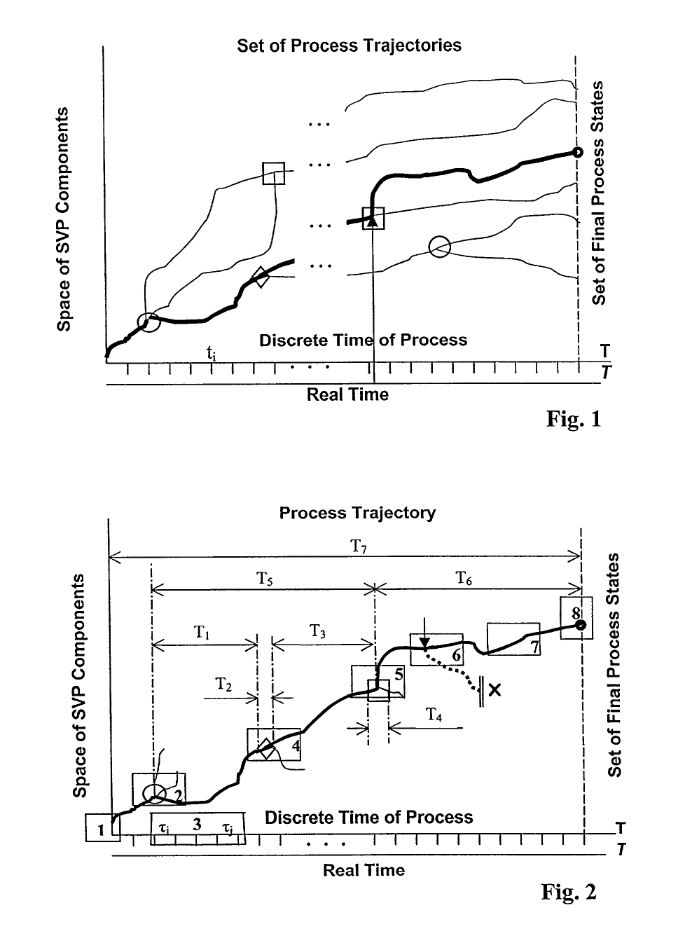

1. Control of authorization to start up the process: checking the entitlements and start up of the process for the authorized user only [1] FIG. 2).

2. Protection of the areas with uncertainties of process, for example, such areas for which the trajectory of the process is defined by using random number generator ([2] FIG. 2).

3. Provision of control over the intervals of discrete time of the process based on valuation of possible intervals τᵢ, τⱼ ([3] FIG. 2).

4. Protection of the areas of interactions between the process and the user: control over the actions and time T₃ ([4] FIG. 2).

5. Protection of the interactions between the process and external events: control of time windows T₄ ([5] FIG. 2).

6. Control of “disjoints” (when the action on the process is unsanctioned) of the process in areas with predetermined trajectory; termination of the process when deviation from the trajectory is detected ([6] FIG. 2).

7. Protection of predetermined areas of the process in order to protect the elements of the program (models, algorithms, parameters and data structures) ([7] FIG. 2).

8. Protection of the final value of the process state vector to prevent changes to its elements after the process completion ([8] FIG. 2).

9. Control of time intervals between the possible and expected internal and external events (T₁, T₃, T₅, T₆).

10. Control of total execution time of the process T₇.

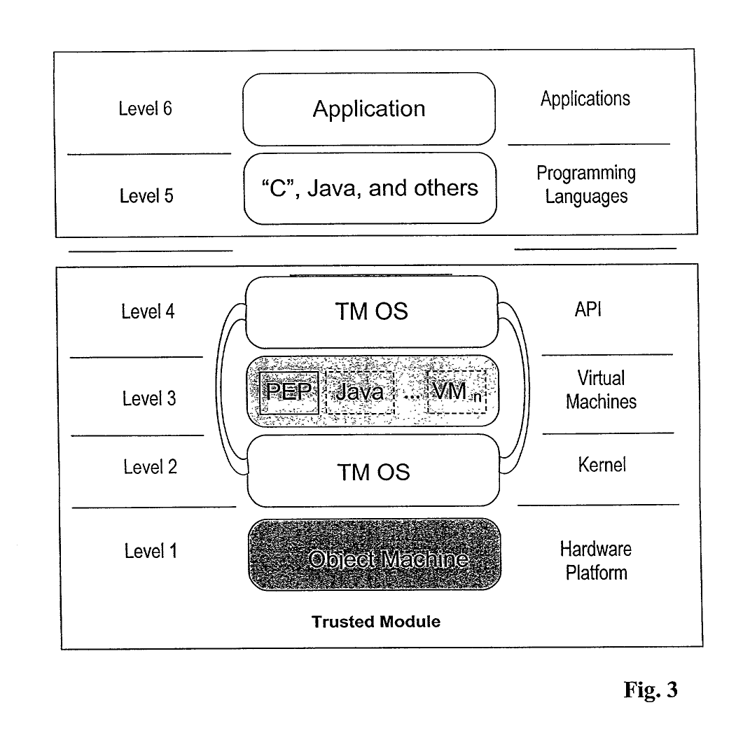

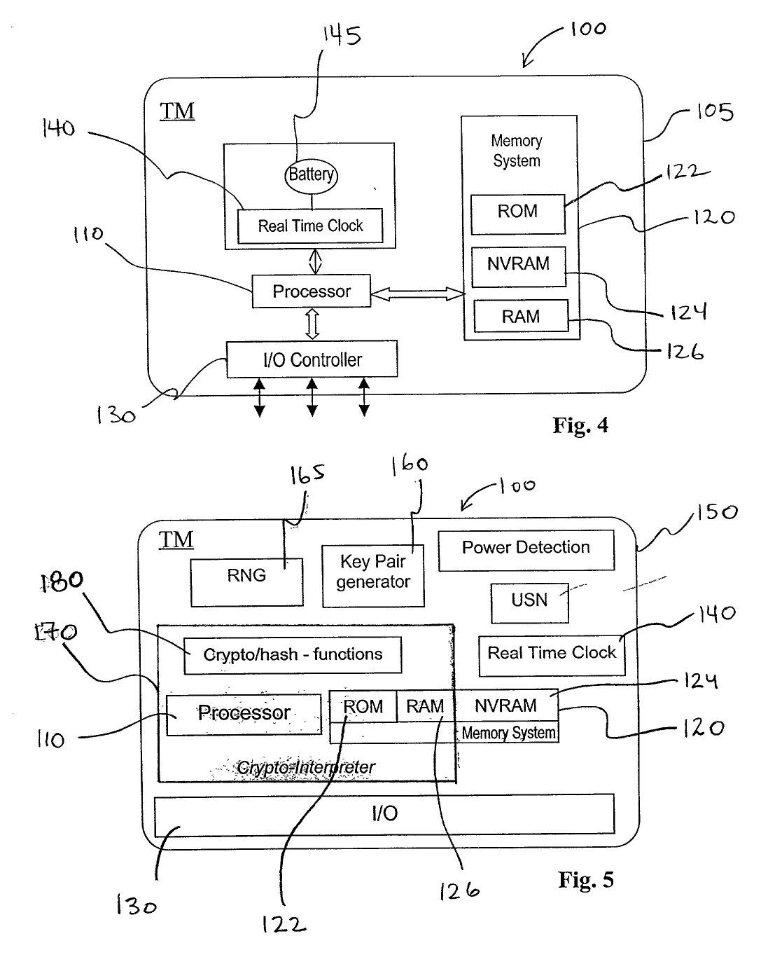

With reference to FIG. 3, there is shown an illustration of an exemplary embodiment of the system architecture of a trusted module for use with the present invention. The trusted module is a specialized physically protected processing device, which can be communicatively connected to a computer. With further reference to FIGS. 4 and 5, the trusted module 100 comprises various hardware components and internal firmware designed to interact with a host computer to jointly execute a protected application. The execution process is described in further detail below. Referring again to FIG. 3, an exemplary multi-level architecture includes, but is not limited to, the following levels:

Hardware platform level (1). At this level there is a hardware implementation of the object machine, which is a microcomputer, as described below.

Kernel level (2). At this level there is a Trusted Module Operating System (“TMOS”) kernel, which controls usage of internal resources of the trusted module and supports logical security functions of the trusted module. In particular, this level contains all necessary cryptographic functions.

Virtual Machine level (3). At this level the system of interpreters is implemented, to support a set of virtual machines.

API level (4). This is a set of interface functions, which the OS provides to protected and host computer processes. Outside the trusted module, two additional levels are implemented:

Application level (6), which is comprised of the algorithmic descriptions of the application processes;

Programming Languages level (5), which is comprised of technology components, which provide special compiling of application software. For instance, it includes special cryptocompilers to compile source code to command set of the target virtual machine.

PEP technology offers the means for development and execution of programs, providing protection from unauthorized intervention from outside into the process of their execution. This means that all the components of the process are protected, namely: a) executable code and data; b) initial, intermediate and final values of the process state vector; c) scale and uniformity of the time of the process flow.

An exemplary embodiment of the object machine 105 structure is shown in FIG. 4. It includes a processor 110, memory system, input/output controller 130, and real time clock 140 with a battery 145. The memory system 120 further includes three types of memory: ROM 122, RAM 126, and NVRAM 124. A description of a preferred embodiment of the physical characteristics of the trusted module 100 is described below. It should be understood that although the following description is currently preferred, the scope of the present invention is in no way limited by the following description of the trusted module 100. The trusted module 100 is preferably a credit card-type device having an internal system architecture. The system architecture preferably comprises a processor 110 having a chip speed of at least 100 mhz or higher. The base processor 110 should preferably have an output of over 80 million ins/sec, while the output of the crypto-interpreter 200 (as shown in FIG. 5) should have an output of up to about 100K ins/sec. The memory 120 of the trusted module 100 preferably has a volume of memory for programs and data of about 64K words or more. The NVRAM 124 preferably has a memory of about 4 megabytes or more and the memory word is preferably 16-bit. It should be noted, however, that any other bit size such as 16-bit, 24-bit, 32-bit, 64-bit, or 128-bit memory could be utilized.

Furthermore, as will become evident from the following discussion of the process protection, the trusted module 100 preferably has an independent internal clock from which to measure time independent of the host computer. As described above, the external construction of the trusted module 100 is preferably either a PCMCIA-like device or a smart card-like device (not shown). The trusted module 100 is equipped to interface with a host computer using any type of bi-directional interface 130 such as for example a standard USB port or a 20-bit bus with three consecutive ports. Of course, the bit size of the bus is not critical to the present invention.

With further reference to FIG. 3, the object machine (Level 1) executes the TMOS kernel of the trusted module, which controls the internal resources of trusted module and the logical security of trusted module (i.e., protection of secret internal objects from unauthorized reading or modification). In particular, the TMOS kernel supports the trusted module's user authentication processes. The TMOS kernel protects the internal integrity of the trusted module by encrypting the sensitive parameters of TMOS Kernel, which are preferably decrypted in RAM only at the time of use. Furthermore, a portion of the segments of the TMOS Kernel are distributed between ROM and NVRAM and are preferably concatenated only at the time of execution.

In the exemplary embodiment, the code of the TMOS Kernel is digitally signed. In an exemplary embodiment where the protected code is encrypted, the public/private key pair is generated inside the trusted module using a key pair generator 160. To prevent the private key from being read from external interfaces, the private key is always maintained inside the trusted module. Thus, there is no way to read private key on external trusted module interfaces.

With reference now to FIG. 5, an exemplary embodiment of the structure of a virtual machine 150 of the trusted module 100 is shown. As described above, corresponding interpretation software 170 supports the virtual machine architecture 150 and, therefore, there are no limitations on the number of virtual machines or the types and number of architecture structures used. In particular, some “open” machines can be supported, such as by way of non-limiting example the Java virtual machine (JVM).

Each virtual machine 150 has its own low-level architecture, defined by a command instruction set (not shown), memory word width, and memory addressing modes, to name a few. In the exemplary embodiment, at least one “protected” machine (referred to generally herein as a “PEP-machine”) must be present in the trusted module. The PEP-machine is programmed with a unique, protected instruction set that corresponds to the instruction set used to compile certain identified segments of a protected application. A “crypto-interpreter” program 170 is designed to interpret object code compiled during the protected application development using the protected instruction set. PEP-machines are also intended to execute enciphered program segments during the interpretation/execution process using a set of defined crypto-functions 180, which may include but are not limited to ciphering functions, hash functions, digital signatures, and message authentication code (MAC) computation. As shown in FIG. 5, the virtual machine architecture 150 may also include a random number generator 165.

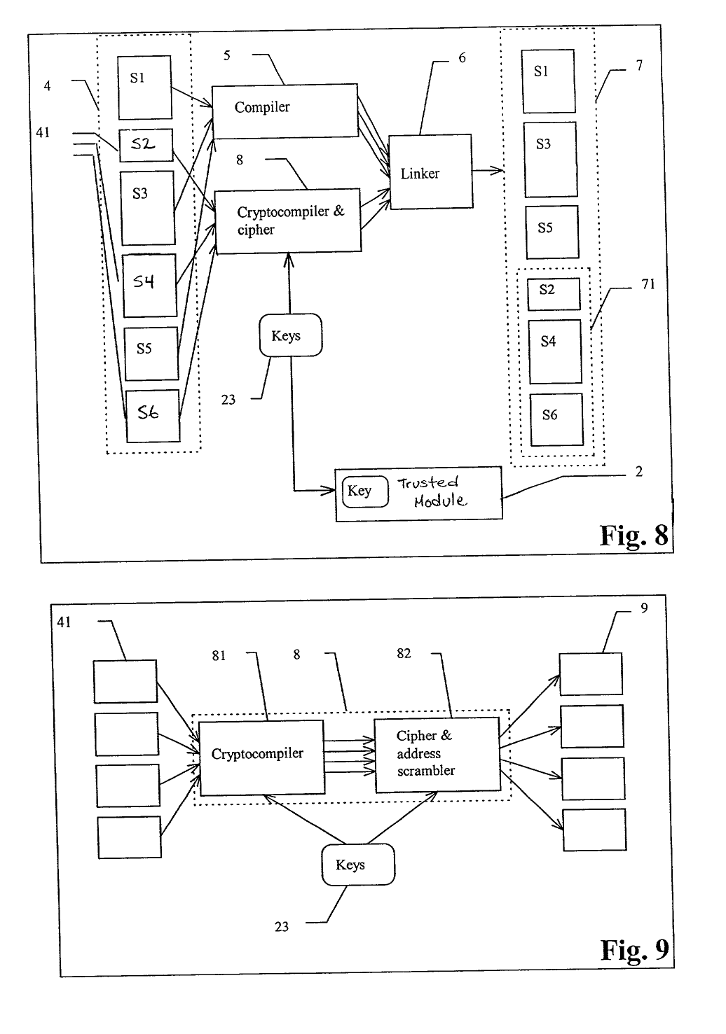

Development of applications for use within the framework of the technology is described and shown in connection with FIGS. 8 and 9. In the exemplary embodiment of the protected application development, a set of program segments is identified. Of course, one skilled in the art will recognize that the selection of these segments is dependent on a particular application as a matter of design choice. This selection can also be performed automatically using some technological software. Moreover, although it is not necessary, it is preferable to protect segments without which the protected software would not perform its functions, or containing algorithms that are not known to the operators of the software. Furthermore, it is preferable that all functions related to the application of cryptographic algorithms and their parameters (keys) should also be protected. Along with the algorithm integrity, protected storage of keys is also a preferred feature.

Thus, the protected process is split into two new processes, interacting with each other the “open” process, which is executed on the open architecture computer, and the “protected” process, which is executed using the trusted module.

With reference to FIG. 8, an exemplary embodiment of a process for the preparation of a protected application for execution within the PEP-machine of the trusted module is shown. The source code 4 of a software product is divided into segments S1 . . . Sn from which segments desired to be protected 41 (e.g., those critical to program execution) are selected. Next, the segments to be executed using the trusted module are compiled using the CryptoCompiler 8. A private key 23 may be used as an additional parameter in compiling the selected segments. The CryptoCompiler is a program for translating the source code of the select segments of the protected program into “CryptoCode”. The CryptoCompiler uses a system of instructions that corresponds to the architecture and instruction set of a particular PEP-machine. The parameters of translation, including the set of instructions, their encoding and other elements of the architecture, can be established according to the additional argument—cryptocompiling key.

Then the segments that are not to be protected (i.e. the ones to be executed by the CPU of the host computer) are converted to object code using a conventional compiler from a high to a low level language 5.

The object code obtained by compiling the protected segments using the CryptoCompiler 8 is combined with the object code obtained by compiling segments to be executed by CPU of the host computer using a linker program 6 to form the resulting software product 7 which, in particular, includes the encoded protected segments of code and static data 71. In this form the protected software may be distributed using commonly used information media, such as CD-ROMs, floppy disks, Internet download, and the like. To execute the software it is necessary to have a trusted module connected to the computer. The corresponding virtual machine must use unique keys matching the keys used for compiling particular program (its protected segments).

The process of cryptocompilation is shown in more detail in FIG. 9. The source code 41 is the input to the CryptoCompiler and enciphering 8 programs. The CryptoCompiler 81 translates the source code into the intermediate object code, which is then encoded and, preferably, but not necessarily, processed by the cipher and address scrambler 82. Then the resulting object code 9 is used as an input to the linker program 6 (FIG. 8). The CryptoCompiler 81 and enciphering program depend on the parameter—keys 23.

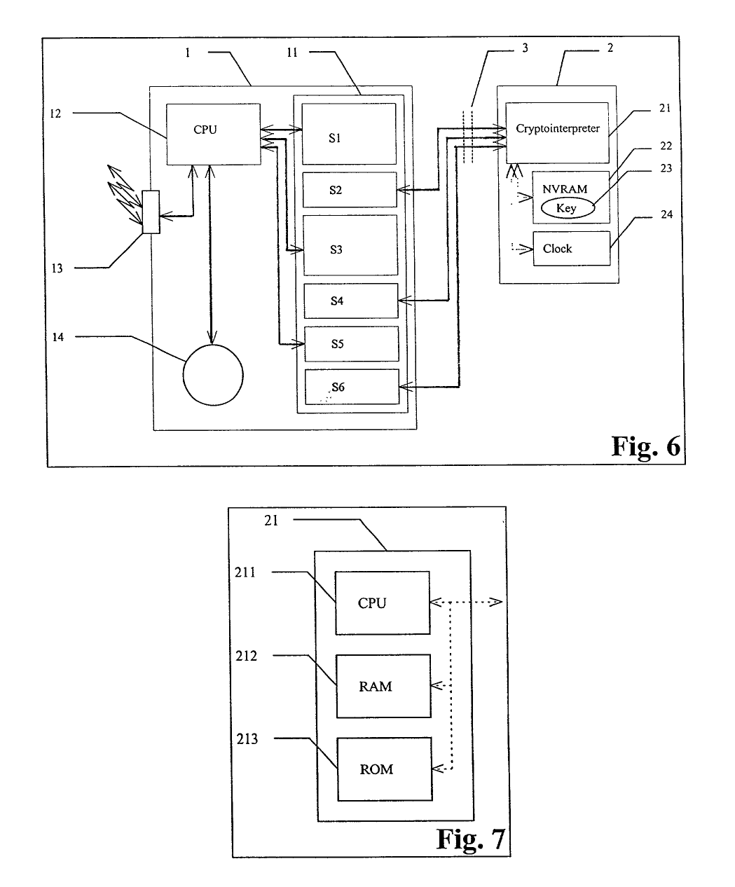

An exemplary embodiment of a combined system used for execution of the protected software is shown in FIG. 6. The system includes the host computer 1 and the Trusted Module 2 connected to the host computer via interface 3, which can be any standard bi-directional interface. Possible examples of such interface include but are not limited to a Universal Serial Bus (USB) or IEEE-1284 parallel port.

The protected software designed for execution within the PEP-machine is loaded into the RAM 11 of host computer 1 from a disk drive or other media 14 or received from a remote computer via a communication adapter 13. The software consists of segments S1, S2 . . . Sn, a number of which (“open” segments, denoted as S1, S3, S5 in FIG. 6) are designed for execution using CPU 12 of the host computer, while the other part (protected segments, denoted as S2, S4, S6 in FIG. 1) are designed for execution using the PEP virtual machine 2. When executing the program the trusted module interacts with the host computer via interface 3.

The design of the Trusted Module 2 provides physical security sufficient to prevent external unauthorized access to the contents of the trusted module including the hardware and internal data areas. One of the possible implementations of the trusted module is a compact single-case device to be connected directly to the port connector of the host computer. Another implementation is a “smart card” form factor device with a set of standard interfaces, to be connected to a special adapter, which, in turn, is connected to the host computer.

The primary components of the Trusted Module are the Cryptolnterpreter 21, a nonvolatile memory 22 and a clock 24. The CryptoInterpreter 21 interprets and executes the commands of the code of the protected program being executed (i.e., the CryptoCode) received from the host computer. The Non-volatile memory 22 can store key(s) 23 used by the PEP Virtual Machine for deciphering of protected program code and can be used for protected storage of sensitive information between the working sessions against external reading/modification. Key(s) 23 should match the keys used when preparing the protected code segments and static program data (S2, S4, S6 in shown FIG. 6).

Some of the functions of Clock 24 allow the trusted module:

(1) to the check time spent by the host computer while executing trusted module requests to read/write host computer RAM,

(2) to the check the time parameters of execution of the selected program segments, including those segments, which are executed on the host computer CPU,

(3) to register or limit time of program usage, independently from the host computer clock, and

(4) to check correctness of the host computer clock.

An exemplary embodiment of the Cryptolnterpreter 21 is implemented, as it is shown in FIG. 7, using a CPU 211, ROM 212 with a control program and RAM 213. In this embodiment, the control program performs functions of deciphering commands and data, interpreting commands and service functions, such as supporting the interface with the host computer and other necessary functions, such as pseudorandom number generation. The RAM 213 contains working data of the control program and may include exchange buffers with the host computer. Another possible implementation of the device includes use of a single-chip microcomputer, which includes the majority (or all) of above listed components to minimize the size and power consumption.

It should be also understood that it is possible to implement the Cryptolnterpreter as an application specific integrated circuit performing all or part of the above listed functions. In addition, the functions of control program can be performed to some extent using hardware or firmware. In particular, support of the interface with host computer, enciphering, deciphering and interpreting of commands of the protected program can be performed either by software (using a control program stored in the ROM of the trusted module and executed by the CPU of the trusted module) or hardware, for example, using finite-state automaton designed as an application specific integrated circuit.

It should be mentioned that the trusted module contains only the interpretation means and not the executable code of the protected program. The code and data of protected segments are stored and distributed together with the open segments on a magnetic disk or other media and loaded into the RAM of the host computer before execution of the program together with non-protected segments. They are fetched by the trusted module when necessary using the procedures which will be described further below.

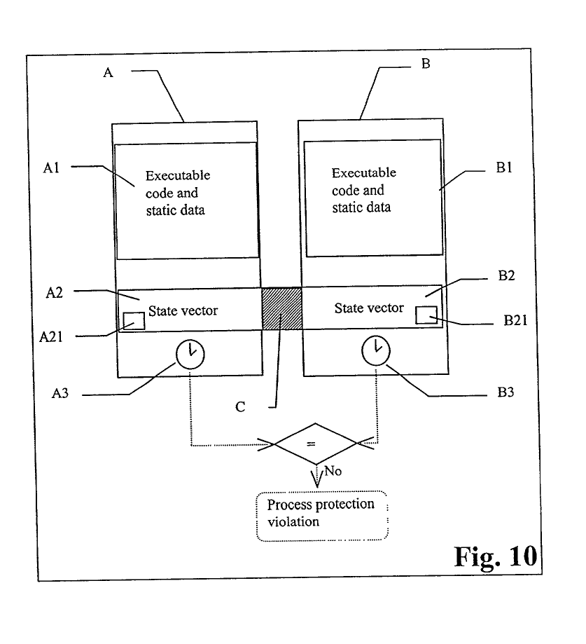

On the logical level, an exemplary process of program execution is illustrated in FIG. 10. While executing the program, at least two processes are generated: the “open” process A, executed by the host computer CPU and the protected process B, executed on the PEP Virtual Machine. Because the protected segments are compiled using the unique instruction set of the CryptoCompiler, the executable code B1 and state vector (data) B2 of the protected process B are not available for reading and/or modification from the host computer. However, code A1 and state vector A2 of the open process A are available for reading and modification due to the open architecture of the host computer. While the program is executed, an interaction of open and protected processes using some inter-processor interaction mechanism (for example, using shared memory window or messages) can be performed, using a shared section of the state vector C. In this case, the protected process can send and receive input and output data, check the state vector of the open process, check the consistency of the state vector, and compare time parameters of processes using the independent clock of the trusted module. Mismatch of any of the controlled parameters of the process is detected and results in setting of the process protection violation flag B21. This event is also communicated to the open process where it results in setting of the process protection violation flag A21. Possible reaction to the detection of security violation can be in particular erasing of the key information, rendering the PEP Virtual Machine unusable, erasing of sensitive information, blocking of processes or other actions.

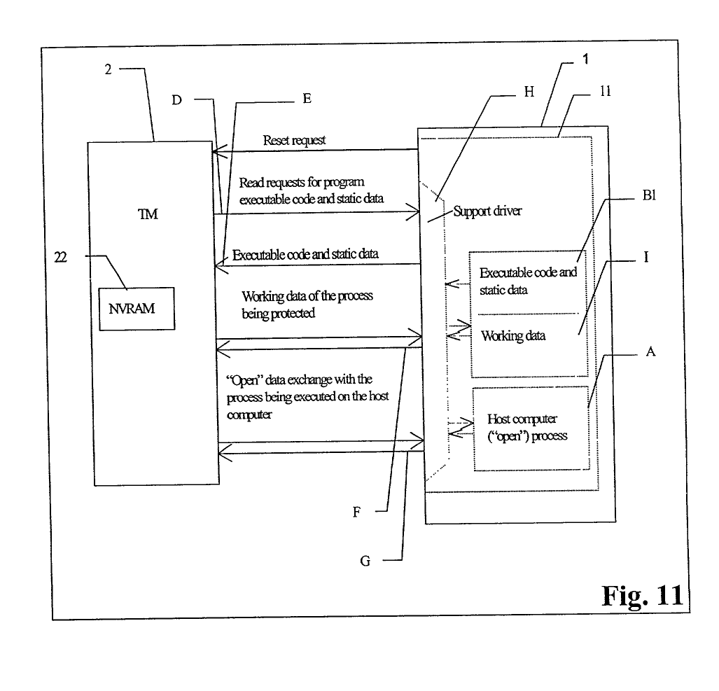

Interaction between the host computer and the trusted module when executing a program developed using the PEP technology of the exemplary embodiment is illustrated by FIG. 11. When executing the protected process, the information exchange between the Trusted Module 2 and the host computer 1 comprises:

requests of the Trusted Module for retrieval of instructions being executed and data of protected program (D);

executable instructions and static (read-only) data of protected process (E) transferred to the Trusted Module upon its requests;

working data of the protected process (F) (data generated and used only within the protected process) transferred to and from the PEP Virtual Machine upon its requests; and

data used for information exchange between the protected process executed by the PEP Virtual Machine and the process of the host computer (G)—input data for protected process and results of its work.

Data exchange between the trusted module and the host computer is performed on requests from the PEP virtual machine. Preferably, the only operation initiated by the host computer is the reset of the virtual machine, which results in initialization of internal state of the virtual machine and start of retrieval of the code of crypto-code from a predefined fixed address. To execute the requests of the trusted module the protected software includes a trusted module support driver H which, in particular, includes interrupt service procedure to handle interrupts of the port being used. RAM 11 of the host computer 1 has an allocated fragment in which the executable code and static data of protected segments B1 are loaded and where the working data of protected process 1 is stored. “Open” process A, executed by the host computer does not need an access to code and data of protected process, therefore the executable code B1 and data I of the protected process can be stored in the memory of the host computer and transferred (information flows D, E, F) to/from the trusted module 2 in an enciphered form. To check crypto-code segments integrity two mechanisms can be used:

(1) Computation of Message Authentication Codes (MACs), using secret keys stored inside trusted module; and/or

(2) Computation of digital signatures using PEP virtual machine public/private key pair.

To transfer input data to the protected process and receive the results back to the “open” process of the host computer, information flow G is used, which is not enciphered. The read/write access to internal NVRAM 22 is given only to the protected process using special instructions. To increase security, data can be stored in NVRAM in enciphered form.

Thus, the described structure of interaction of the trusted module and the host computer can serve as a base for at least the following:

protection of code and data of the process being executed from unauthorized reading by enciphering them when stored in the host computer memory;

detection of unauthorized modification of code and process data when stored in host computer memory using MACs or digital signatures;

independent (from the host computer clock) checking of time parameters of the protected process;

inaccessible (for unauthorized modification) storage of critical data in NVRAM of the trusted module with possible transfer of the data to another computer together with the trusted module.

When the trusted module detects an attempt to influence the course of the process (e.g., detects attempts to change code or data while using MACs or detects discrepancy in time parameters of the executed process compared to the expected ones or detects other indications of unauthorized interference in the process execution) the control program of the trusted module can disable the PEP Virtual Machine by erasing the code de/enciphering key or by setting an event flag of a detected attempt of external interference in trusted module work in a reserved section of NVRAM. Other reactions may be used so long as the operation of the execution of the process is disabled and, thereby protected.

The present invention offers at least two ways of protected execution process organization: by word-by-word retrieval and interpretation of commands of the code of the protected program and by loading executable code of the program in fragments or segments. Below are descriptions of exemplary embodiments of the two indicated schemes:

Word-by-word Retrieval of Protected Program Code

When performing word-by-word retrieval of the program code, the information exchange between the trusted module and the host computer is carried out by transmitting separate data words. The size of the words is determined by the architecture of the specific virtual machine. For instance, the PEP-machine may include a 16-bit instruction set which would provide for 16-bit size of a word. As such, when sending requests, the trusted module transfers to the host computer a request code and address of the required word relative to the start address of the memory window of the host computer allocated to work with the trusted module for this virtual machine. In the case of a read request, the trusted module sends the host computer the request code, the address of the word and the data word itself to be written at the indicated address.

Cryptographic methods can be used to provide protection of information stored in the host computer (e.g., executable code and working data of the process). Executable code and static data of the program can be enciphered in word-by-word mode using a secret key. The key is defined at the compilation stage and stored into the NVRAM of the trusted module. Subject to the purposes of protection, the same keys can be used for several copies of protected software or can be unique for every specific copy.

To increase cryptographic security it is possible to introduce an additional parameter into the enciphering algorithm such as a word address in the address space of the PEP-machine, so that the same word located at different addresses is represented by different words after enciphering.

It should also be noted that a fixed key is necessary for the enciphering of executable code of the program and constants. This key, therefore, must be defined at the preparation (compiling) stage of the protected program. To encode the working data, generated and used only by the protected process at the time of execution, it is possible to use a new key for each new working session. For instance, a new enciphering key for the working data of the virtual machine may be designed at every new run of the program (when initializing the virtual machine). This key can be generated for example by using a built-in random number generator.

An additional measure aimed at hampering of the analysis of the algorithm and the state of the executed process when using word-by-word retrieval can be scrambling of words addresses when storing them in the memory of host computer. In this case, the words positioned in address space of the virtual machine are mapped to pseudorandomly located words in the address space of the host computer allocated for their storage. When executing a linear segment of the protected program, the requests of the virtual machine to the memory of the host computer appear to be random to the external observer. The above-mentioned reasoning related to the enciphering of working data of protected process also applies to scrambling of addresses of the working data generated and used only by the protected process at time of execution, i.e., it is advantageous to use a newly generated pseudorandom key for address scrambling of data in each new working session.

To provide data exchange with the “open” process of the host computer (communication of input data and results of calculations) special requests supported by a driver and the TMOS are used, or an open memory window is allocated in the logical address space of the virtual machine and no enciphering and address scrambling is used for reading and writing in this window. In the latter case, all communications between the open and protected processes can be performed by data in a pre-defined format through the allocated exchange window as it is performed in multiprocessor systems with a shared memory window. Or, in addition to the above, it is possible to introduce interrupt requests to implement asynchronous interprocess communications.

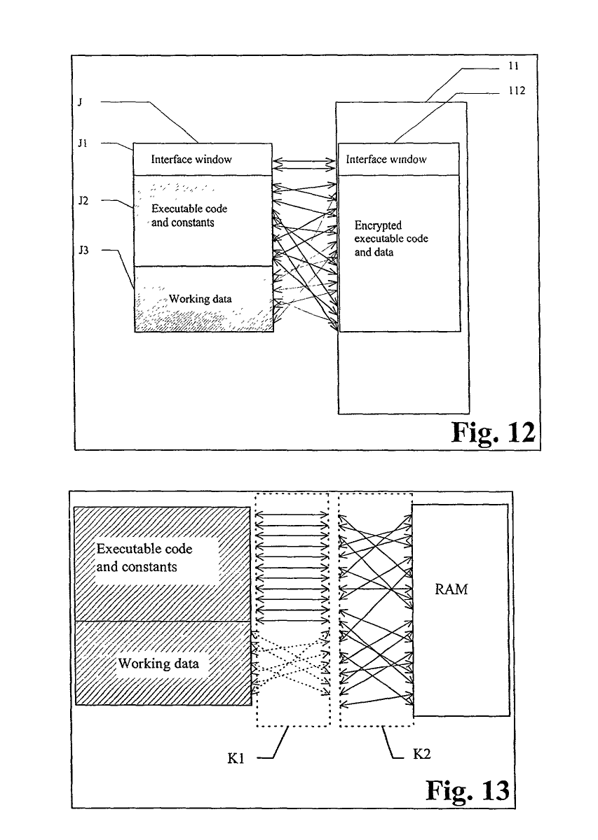

FIG. 12 illustrates an exemplary mapping of logical address space of the virtual machine to allocate a fragment of the host computer RAM when using address scrambling and shared memory window for open information exchange. A window corresponding to the logical address space of the virtual machine J is allocated in the main memory 11 of host computer. In the address space of the virtual machine J1, a window is allocated to exchange open data with host computer processor—the window mapped to the corresponding memory window of the host computer. In this example, no address scrambling is carried out and no en/deciphering is made when reading/writing memory words of the interface window. The other part of the logical address space of the virtual machine is separated to domain J2 occupied by executable code and static data of the program and domain J3 allocated to store working data of protected process. To en/decode data and scrambling addresses of domain J3 a new key is used for every new working session of the virtual machine. A built-in random number generator of the trusted module may generate this key.

The dotted arrow lines of FIG. 12 show the matching of addresses changing session by session, which match the session key parameter. One of the possible implementations of such mapping can be the superposition of two mappings shown in FIG. 13. Mapping K1 of the working data window is preferably determined by a session key parameter. Mapping within the window of code and constants may be identical one-to-one. Mapping K2 is performed for all protected sections of the address space and is defined by a fixed key assigned during the preparation (compiling) stage.

An additional measure aimed at hampering program logic analysis can be the generation of requests, which are independent of the work of the protected process, to the host computer memory (to pseudorandom addresses at pseudorandom time intervals for reading/writing to an unused memory region) from the trusted module. By way of example only, addresses above some address in the address space of the Virtual Machine may be used. These operations result in some additional load on the interface between the host computer and the trusted module and, therefore, they should not be performed too often.

An additional measure aimed at hampering of program logic analysis can be the redundant recording of a number of copies of executable code and static data of the program into a window allocated in the main memory of host computer, so that at a specific address in the address space of the Virtual machine there would be the first copy, then—the second copy, etc. until all the allocated address space is consumed. Taking into account address scrambling, the copies will be “randomly” mixed in the memory window of the host computer allocated for trusted module programs and data. Considering the dependency of the enciphering algorithms on the address in address space of the virtual machine, the words of different copies will be mapped to different words after enciphering. When executing the program, the control program of the trusted module can select words of arbitrary copies of program using a pseudorandom algorithm for copy selection. A simple design can be the separation of copies in logical address space of the Virtual Machine by a fixed distance dA and virtual machine's reading, instead of the word at the address a, the word at the address a+dA*r, where r is a number generated by random number generator and r is less than the number of copies of code and static data of the program stored in the address space of the virtual machine.

An additional measure aimed at hampering of program logic analysis can be checking of the host computer reaction times to requests of word read/write by the OS of the trusted module. If the time between the request of the trusted module and the time of actual receiving data from the host computer (or the time of acknowledgment of data receipt by the host computer) t is above maximum acceptable t max, which is defined considering possible assumptions of host computer load, the TMOS declares an attempt of external interference in the process execution.

If it is necessary to check the authenticity of program code and data (i.e., detect unauthorized modifications of code and program data), it is possible to introduce information redundancy by adding a MAC to each of the words, the checksum depending on a secret key and data block address. The size of this MAC should be determined based on a compromise between the cryptographic security (growing as the size of MAC grows) and intensity of exchange between the trusted module and the host computer (also growing as the size of MAC grows). The above considerations of permanent and variable session keys are also applicable to the selection of a key.

Retrieval of Protected Program Code by Fragments/segments

Loading code of protected program by fragments or segments of relatively large size makes it possible to decrease the data exchange between the trusted module and the host computer at the price of making the trusted module more sophisticated: increasing the size of RAM and, therefore, power consumption and cost of the device.

Using fixed fragments of relatively large size allows the system to use block enciphering algorithms with the size of a block corresponding to the size of the fragments, which increases the cryptographic security of this scheme compared to enciphering of single words in the above scheme of word-by-word exchange.

Using fixed fragments of relatively large size also justifies use of MACs for checking the integrity of information during its storage in the host computer, since the growth of code and data size and the corresponding growth of the information transferred to and from the trusted module is not so important as it is when adding a MAC to each word in the word-by-word exchange scheme.

When using code fragments of small size, it is possible to implement the above indicated schemes of address scrambling, the only difference being that the whole fragments are rearranged instead of words.

To increase cryptographic security it is possible to introduce an additional parameter—address of the protected fragment—to ciphering algorithms.

It should be understood that in addition to the variants listed above it is also possible to implement intermediate variants, such as word-by-word access with cache buffer in the trusted module RAM to optimize data exchange with the host computer or organizing a paged memory with swapping from/to the host computer RAM.

Protection from Unauthorized Reading of the Executable Code (Algorithm) and Data

The protected software, prepared using the PEP-technology, includes protected fragments or segments, as described above. These fragments are preferably enciphered using symmetric algorithm using a secret key. While executing the program, the protected fragments of code and data are stored in the host computer RAM only in an enciphered form. Deciphering is performed by the trusted module in the course of execution (interpretation) of executable code or data retrieval. Deciphering keys are stored in NVRAM or ROM of the trusted module and are not available for external reading and modification due to the physically and logically protected design of the trusted module. This makes the reading of the program code before, after and during its execution impossible.

Protection from Unauthorized Alternation of Executable Code or Static Data of the Program (Authentication of Program and Data)

When using MACs to check the integrity of protected code and data, the code fragment or individual words (depending on the used scheme of protected execution) are preferably complimented by MACs obtained by using cryptographic algorithms with a secret key selected in the preparation (compiling) stage of the program. The corresponding key is written into the NVRAM or ROM of the trusted module.

While executing a protected program, the MAC is preferably transferred to the trusted module together with the corresponding program fragment or word. The trusted module validates the checksum of the fragment or word received from the host computer using the key stored in its NVRAM or ROM and continues executing the protected program if the MAC is correct. In instances where the MAC is incorrect, an attempt of external interference in execution process is declared.

Both symmetrical cryptographic algorithms (MACs with secret key) and asymmetrical cryptographic algorithms (digital signatures with public/private keys) can be used for computation of integrity check information. It is possible to use a single secret key to calculate and check a MAC, since the key is stored in NVRAM or ROM of trusted module and is not available for external reading and modification due to the physically and logically secure design of the trusted module. The use of asymmetrical algorithms (public/private) can have an additional advantage since the key and algorithms required to check a digital signature are not secret and can be published, for example, for possible static checks of code and data authenticity (without the trusted module). It also eliminates the need to store key used to form code fragments MACs inside trusted module, which can be preferred in some applications.

Protection from Unauthorized Reading of the Current State of the Process being Executed at any Point of its Execution

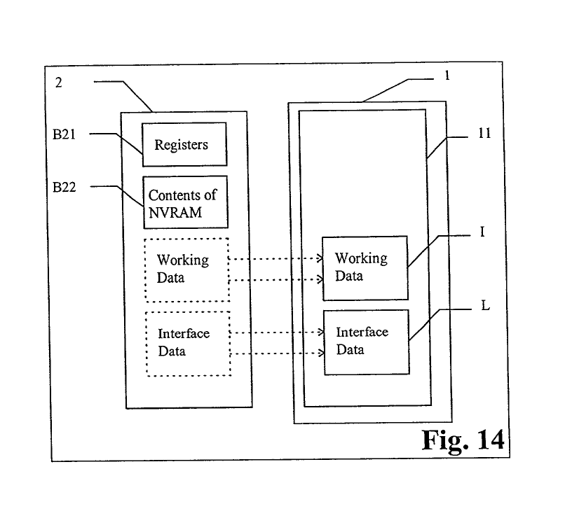

FIG. 14 shows the data (the components of the process state vector) of the protected process B2, which includes the following:

contents of the internal registers B21 of the PEP Virtual Machine, including, in particular, program counter (address of the next instruction to be executed);

contents of NVRAM B22 (critical information of long-term storage);

the working data of the process 5, stored in host computer RAM 11;

data L received or transmitted to the “open” process of the host computer.

Data B21 and B22 are stored in the physically and logically protected trusted module 2 and, therefore, are not available for external observation. The program counter of the virtual machine (address of the next instruction to be executed) can be indirectly located using the analysis of the sequence of requests to the host computer memory. But the use of the above described address scrambling, variable address mappings and additional pseudorandom requests to the host computer memory from the trusted module will complicate the localization of the address.

Data I is stored not within the physically secure trusted module 2, but rather in the RAM of the host computer 11, and is potentially available for observation. Nevertheless, since it is stored in an enciphered form using a secret enciphering key (which can be either fixed or unique for each new working session) a “sensible” reading of this data from the host computer is impossible.

Data L is designed for information exchange with the open process of host computer and, therefore, cannot be enciphered. However when the functional interface between the “open” and protected parts of the program is organized correctly pursuant to the teachings herein and application specific design needs, the security of the system should not be compromised.

Protection from the Introduction of Unauthorized Changes into the Current State of the Process being Executed at Some Point of its Execution

Referring to FIG. 14, we should note that the internal registers of the virtual machine B21 preferably include, in particular, the program counter of the virtual machine (address of the next instruction to be executed) and NVRAM B22, are located in the physically and logically protected trusted module 2 and, therefore, are not accessible for external modification. The working data I of the process, stored in the host computer RAM 11, are supplied by MACs calculated by the trusted module using a secret key, which can be different for every new working session. While transmitting data and the corresponding MACs back to the trusted module, the latter validates the integrity of the data by calculating MACs and matching them to the ones received from the host computer together with the data. If they do not match, the TMOS kernel of the trusted module declares external interference in the process execution.

When working with the data L, received or transmitted to the “open” process of the host computer, calculation and checks of MACs are not performed, since this data are used for information exchange with the open process of host computer and, in particular, for receiving information from “open” process of the host computer.

Monitoring and Checking of Time Parameters of the Process Being Executed

As described above, checking the time parameters of the protected process during execution is a primary aspect of protecting the integrity of the process. Checking of the process time parameters is preferably carried out at several levels.

First, at the low level, the TMOS checks the time period between the issue of a request for a service to the host computer and the fulfillment of the request. In other words, the time period between the reading or writing of a word or data block (the request) and the reception of the required word or data block or a confirmation of reception of the word or data block (the fulfillment) is measured. According to the exemplary embodiment of interaction between the trusted module and the host computer, the requests of the trusted module are executed by the driver being called using the interrupts of communication port. Thus, the service time of a request should be rather short and should not depend very much on the kind of work performed by the host computer program during a particular time period. On the other hand, the use of some means (e.g., debugger) to study the logic of the protected program by a hacker would have a high probability of increasing request's execution time. In some applications, the time of execution of a particular fragment of protected program can have an important value itself and it is necessary to prevent artificial expansion of this time. When loading large fragments for execution into the trusted module, the invariability of time parameters during execution of the fragment is ensured by the physical protection of the trusted module and its independence from the clock rate of the host computer. In instances where word-by-word retrieval is used, the invariability can be ensured to some degree by controlling the time of fulfillment of requests for reading/writing of words to and from the host computer memory.

Second, during execution of an application, an interaction of the protected process and the open process is performed. Thus, the time of execution of particular open fragments of the program should also be checked. This function is performed by the protected process, which, if necessary, can check (using the Trusted Module's clock) time intervals between specific events of the open process (for example, between calls to functions of the protected program), as well as match the internal time of the Trusted Module with the system time of the host computer to check the synchronism (keeping time scale and uniformity) of processes' execution.

Finally, the trusted module clock can be used to calculate the time of usage of protected software, which (combined with NVRAM) can be used for software rental and other purposes.

Monitoring and Checking of the Open Fragments of the Process being Protected

In order to ensure the integrity of the whole process, it is necessary to monitor fragments or segments of the process being executed on the host computer (the “open” process). In general, this task is somewhat intractable, due to the number of components in the full vector of state of the open process and the variability of these components. To simplify this task the exemplary embodiment uses the following approaches:

reduce the full vector SVP (p₁, p₂, . . . , p_{N}|tᵢ) to the shortened SVP (p₁, p₂, . . . ,p_{M}|tᵢ), where M<N.

compute coordinates only at selected points t₁ instead of computing at all values in [t₁,T].

Use macrocomponents instead of separate SVP components, to characterize by the single value the state of a set of components. Examples of such macrocomponents could be state of stack, state of selected memory regions, or result of a one-way hashing function over a set of monitored parameters.

It is also possible to establish trust intervals, defining the allowable mismatch of the expected and actually observed trajectories. The trusted module carries out comparison of the expected and observed trajectories, and sets the process protection violation flag if a mismatch is detected. One skilled in the art will recognize that further actions could be used as a matter of application specific design choice.

Providing an Ability to Store Results of Computer Program in Non-volatile Memory of a Detachable Device, so That These Results can be Later Used by the Program or Transferred to another Computer

The built-in non-volatile memory of the trusted module can be used by a protected program to store specific information, providing protection from external read/write access to this information.

Since the trusted module is a compact device which can be easily disconnected from the host computer, it can be used to transfer the data in NVRAM to another computer, processing center, etc., combining the functions of the trusted module and a cartridge for transfer of specific information.

Protection of the Non-volatile Memory from Unauthorized Access

The read/write operations data from and to NVRAM can be performed only by the protected process. These operations are commands of the PEP virtual machine of the trusted module. Accordingly, when using MACs to provide authentication of executable code and data of protected program, it is possible with high probability to avoid the possibility of substitution of code or data fragments, resulting in reading/writing of NVRAM.

Provision to Make Each Copy of Software Unique with Ability to Provide Means of Access Control.

When using unique keys for each of the produced copies of a program (for enciphering, address scrambling and/or generation of MACs of executable code and static data of protected programs), the copy can be executed only using the trusted module with the corresponding keys.

The programmable structure of the crypto-compilation process and possible control over the keys distribution potentially allows for more flexible control over protected programs preparation, distribution, and execution. For instance, it is possible to create a set of programs, which can be executed only using the specific trusted module, or to create a single program, which can be executed using a specified set of trusted modules.

Along with binding of a specific copy of software to a specific device at the time of software compilation, it is also possible to bind software, manufactured separately and delivered to the user later, using communication networks or other transport. If this ability is supported, the new software is deciphered, its integrity is checked using corresponding public key of software provider, and the protected software is stored, ready to execute, in the host computer, in the re-encrypted form. During this re-encryption process, deciphered code or data do not appear outside the physically protected trusted module.

Using the physically protected security kernel of trusted module and/or dynamically loadable PEP-processes, more sophisticated access control both to the processes and to the static data can be implemented. In particular, it is possible to implement a discretionary access control scheme, when, at the moment of instance of data or a program creation, a list of processes, with corresponding access types, is specified. It is also possible to implement non-discretionary access control schemes, for example, multi-level mandatory or role-based access control. In the latter case it is possible to associate particular PEP-processes, implementing required access modes, with the data being protected, and assign the corresponding access rights to these PEP-processes.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention.

We claim:

1. A method of securely executing a software application on a host computer and coprocessor, the method comprising:
selecting a first set of segments of the software application to be executed on an open architecture system;
selecting a second set of segments of the software application to be executed only by a closed architecture system;
compiling the first set of segments using a first compiler into a first set of code;
compiling the second set of segments using a second compiler into a second set of code;
linking the first and second sets of code;
executing the first set of code on the open architecture system of the host computer; and
executing the second set of code only on the closed architecture system of the coprocessor.

2. The method of claim 1, wherein the step of processing the software application further comprises processing results of the execution of the first and second sets of code through interaction between the host computer and the coprocessor.

3. The method of claim 1, wherein the step of processing the software application further comprises:
storing at least the second set of code in a memory of the host computer;
transmitting a portion of the second set of code to the coprocessor; and
interpreting the portion of the second set of code in the coprocessor.

4. The method of claim 3, wherein the transmitting of the portion of the second set code to the coprocessor comprises transmitting the portion of the second set of code in a ciphered form.

5. The method of claim 4, wherein the interpreting of the portion of the second set of code comprises deciphering the portion of the second set of code.

6. The method of claim 3, wherein the transmitting of the portion of the second set of code comprises transmitting the portion of the second set of code in a word-by-word mode and the interpreting of the portion of the second set of code comprises interpreting the portion of the second set of code in a word-by-word mode.

7. The method of claim 6, wherein the transmitting of the portion of the second set of code in a word-by-word mode further comprises:
receiving a word of the portion of the second set of code in a ciphered form; and
deciphering the word using a key stored in a memory of the coprocessor.

8. The method of claim 7, wherein a memory address of the word is used as an additional key.

9. The method of claim 6, wherein the transmitting of the portion of the second set of code in a word-by-word mode further comprises scrambling a memory address of the word.

10. The method of claim 6, wherein the transmitting of the portion of the second set of code in a word-by-word mode further comprises inserting randomly generated requests to the memory of the host computer by the coprocessor.

11. The method of claim 3, wherein the transmitting of the portion of the second set of code comprises transmitting the portion of the second set of code in segments and the interpreting of the portion of the second set of code comprises interpreting the portion of the second set of code in a segment-by-segment mode.

12. The method of claim 11, wherein the transmitting of the portion of the second set of code in segments further comprises:
transmitting an authorization code along with each of the segments; and
checking the authorization code upon receipt of one of the segments in the coprocessor.

13. The method of claim 1, further comprising enciphering the second set of code using a key corresponding to a key stored in a memory of the coprocessor.

14. The method of claim 1, further comprising storing the linked first and second sets of code on a machine readable storage device.

15. The method of claim 1, further comprising making the linked first and second sets of code accessible from a remote location.

16. The method of claim 1, further comprising checking a time period during processing between issuance of a request by the coprocessor and fulfillment of the request by the host computer.

17. The method of claim 16, wherein the time period is measure by a clock integrated within the coprocessor.

18. The method of claim 1, further comprising matching a time value of a clock of the coprocessor with a time value of a clock of the host computer during processing.

19. The method of claim 1, further comprising calculating a time of usage of the software application using a clock of the coprocessor.

20. A system for securely executing a protected application, a first portion of the protected application compiled using an open architecture instruction set and a second portion of the protected application compiled using a protected instruction set, the system comprising:
a host computer programmed with the open architecture instruction set so as to be capable of executing only the first portion of the protected application; and
a trusted module communicatively connected to the host computer, the trusted module having a coprocessor programmed with the protected instruction set so as to be capable of executing the second portion of the protected application;
wherein the protected application is processed through execution of the second portion of the protected application on the trusted module and execution of the first portion of the protected application on the host computer.

21. The system of claim 20, wherein the coprocessor of the trusted module is further programmed with a second open architecture instruction set.

22. The system of claim 20, wherein the protected application is stored on the host computer and segments of the second portion of the protected application are transmitted to the trusted module in response to requests for the segments by the trusted module

23. The system of claim 22, wherein the protected application is stored in an enciphered form.

24. The system of claim 22, wherein the segments are transmitted to the trusted module in an enciphered form.

25. The system of claim 22, wherein the segments are transmitted to the trusted module along with authorization codes and the trusted module checks the authorization codes.

26. The system of claim 20, wherein the protected application is stored on the host computer and the second portion of the protected application is transmitted to the trusted module in word by word.

27. The system of claim 26, wherein the protected application is stored in an enciphered form.

28. The system of claim 26, wherein each word transmitted to the trusted module is in an enciphered form.

29. The system of claim 26, wherein each word is transmitted to the trusted module along with an authorization code and the trusted module checks the authorization code.

30. The system of claim 20, wherein the trusted module further comprises:
a communication interface for communicating with the host computer;
a memory for storing keys for deciphering the second portion of the protected application; and
a clock.

31. The system of claim 30, wherein the communication interface is a universal serial bus.

32. The system of claim 30, wherein the communication interface is a parallel port.

33. The system of claim 32, wherein the parallel port is on the IEEE-1284 type.

34. The system of claim 30, wherein the memory is a non-volatile memory.

35. The system of claim 30, wherein the keys stored in the memory match keys used to encipher the second portion of the protected application.

36. The system of claim 30, wherein the clock checks a time interval spent by the host computer to execute requests of the trusted module.

37. The system of claim 30, wherein the coprocessor limits usage of the protected application based on a time value measured by the clock.

38. The system of claim 37, wherein the time value is predefined.
